(19) United States
(12) Patent Application Publication
(10) Pub. No.: US 2013/0019580 A1
(43) Pub. Date: Jan. 24, 2013

(54) BIDIRECTIONAL HARVESTING SYSTEM

(71) Applicants: Noel W. Anderson, Fargo, ND (US); Alan D. Sheidler, Moline, IL (US)

(72) Inventors: Noel W. Anderson, Fargo, ND (US); Alan D. Sheidler, Moline, IL (US)

(21) Appl. No.: 13/246,213

(22) Filed: Sep. 27, 2011

Related U.S. Application Data
(63) Continuation-in-part of application No. 13/187,109, filed on Jul. 20, 2011.

(51) Int. Cl. A01D 69/00; B65G 67/02

(52) U.S. Cl. 56/11.2; 414/345; 414/809

(57) ABSTRACT

A bidirectional material source vehicle including a base unit and at least one material gathering device. The base unit is movable in a first travel direction and a generally opposite second travel direction. The at least one material gathering device is carried by the base unit. The at least one material gathering device is positioned at a first end of the base unit when the base unit is traveling in the first travel direction, and is positioned at a second end of the base unit when the base unit is traveling in the second travel direction.

### CROSS REFERENCE TO RELATED APPLICATIONS

This is a continuation-in-part of U.S. patent application Ser. No. 13/187,109, entitled “MATERIAL TRANSFER SYSTEM”, filed Jul. 20, 2011, which is incorporated herein by reference.

### FIELD OF THE INVENTION

The present invention relates to a harvester system, and, more particularly, to a bidirectional harvesting method and apparatus.

### BACKGROUND OF THE INVENTION

A grain harvesting combine includes a header, which cuts the crop and feeds it into a threshing rotor. The threshing rotor rotates within a perforated housing, performing a threshing operation of the grain from the crop directed there in to. Once the grain is threshed it falls through perforations in the housing onto a grain pan. From the grain pan the grain falls through a set of upper and lower sieves that are known as the cleaning shoe. The sieves are vibrating or oscillating causing clean grain to fall through for the purposes of collection of the grain and the removal of the chaff or other debris. The cleaning fan blows air through the sieves to discharge chaff toward the rear of the combine. Crop residue such as straw from the threshing section proceeds through a straw chopper and out the rear of the combine.

The clean grain is gathered into a clean grain reservoir and when the reservoir is full the operator interfaces with an operator of a grain hauling vehicle to transfer the grain from the reservoir to the grain hauling vehicle. As shown in FIG. 1, grain can be transferred as the harvester and the grain hauling vehicle are both moving in a forward direction.

If the harvester is stationary a skilled operator can back a vehicle to position it so that it can receive the grain from the harvester. A great deal of skill is required to back a straight truck in coordination with a harvesting machine as is demonstrated at http://www.youtube.com/watch?v=P91KAKD7tpc

Considerable skill is needed to back the vehicle up to a stationary harvester if the grain hauling vehicle is a tractor/grain cart combination. Even more skill is required if the grain hauling vehicle is a tractor/wagon combination. It is virtually impossible for an operator of any skill level to controllably back a grain hauling vehicle if the vehicle is a tractor with two grain containers connected in series. It is simply impossible for an operator to coordinate the backing of a tractor and a towed vehicle relative to a discharge auger of a harvester as the harvester is harvesting grain at a normal operating speed. The high speeds of both the harvester and the carts would require split second adjustments and when added to varying field conditions such as ruts and moisture, as well as poor visibility and limited ability to judge distance between the leading cart and header are but a few reasons why this is impossible to achieve using the prior art.

Automatic car parking systems are known where the car has no hitched element and the parking spot is in a fixed location. Also it is known to have a truck tractor and trailer system that backs up the rig to a stationary dock.

An example of a harvesting vehicle that uses a material receiving vehicle a substantial amount of the time can be seen at http://www.youtube.com/watch?v=xR2GAjHvuD4. This illustrates a cane harvesting process, where billets are transferred to the material receiving vehicle during the entire harvesting process. One of the problems with the prior art harvesting process is that there is a delay required each time a material receiving vehicle is filled and another one takes it place, requiring the empty vehicle to replace the filled material receiving vehicle as can be seen at http://www.youtube.com/watch?v=9jEgNZp9Aoc&feature=related, which shows the harvesting delay of switching material receiving carts. Another problem encountered is the need to turn a harvester around to continue the harvesting operation.

What is needed in the art is a method and apparatus to efficiently continue the harvesting operation when arriving at the ends of rows or swaths.

### SUMMARY

The invention in one form is directed to a bidirectional material source vehicle including a base unit and at least one material gathering device. The base unit is movable in a first travel direction and a generally opposite second travel direction. The at least one material gathering device is carried by the base unit. The at least one material gathering device is positioned at a first end of the base unit when the base unit is traveling in the first travel direction, and is positioned at a second end of the base unit when the base unit is traveling in the second travel direction.

The invention in another form is directed to a bidirectional material source vehicle including a base unit and at least one material gathering device. The base unit is movable in a first travel direction and a generally opposite second travel direction. The base unit includes a first interface device associated with a first end of the base unit and a second interface device associated with a second end of the base unit. The at least one material gathering device is connectable to the first interface device when the base unit is traveling in the first travel direction and connectable to the second interface device when the base unit is traveling in the second travel direction.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematical top view of a prior art two vehicle system utilizing a material transfer system;

FIG. 2 is a schematical top view of a two vehicle system utilizing an embodiment of a material transfer system of the present invention;

FIG. 3 is a schematical top view of another two vehicle system utilizing the material transfer system of FIG. 2;

FIG. 4 is a schematical top view of the two vehicle system utilizing the material transfer system of FIG. 3;

FIG. 5 is a schematical top view illustrating another use of the material transfer system of FIGS. 2-4;

FIG. 6 is a schematical top view illustrating another use of the material transfer system of FIGS. 2-5 with a bidirectional harvester;

FIG. 7 is a schematical top view of the vehicle system utilizing the material transfer system of FIGS. 2-6;

FIG. 8 is a block diagram illustrating some of the interconnections of the material transfer system of FIGS. 2-7;

FIG. 9 is a schematical top view illustrating another view of the bidirectional harvester of FIG. 6; and

FIG. 10 is another schematical top view illustrating another embodiment of the bidirectional harvester of FIGS. 6 and 9.

Corresponding reference characters indicate corresponding parts throughout the several views. The exemplifications set out herein illustrate one embodiment of the invention and such exemplifications are not to be construed as limiting the scope of the invention in any manner.

### DETAILED DESCRIPTION

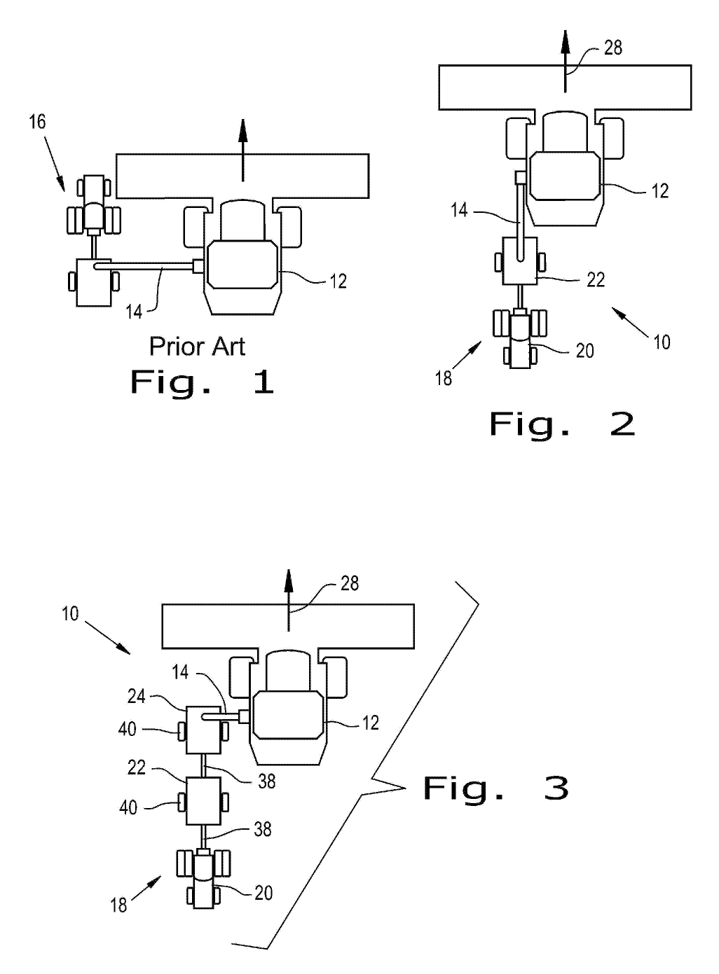

Referring now to the drawings, and more particularly to FIG. 1, there is illustrated a prior art material transfer system with a material source vehicle 12 here illustrated as a harvester 12 having a material discharge device 14 that discharges grain into a material receiving vehicle 16, which is here illustrated as a tractor and grain cart. As harvester 12 is moving in the indicated direction the tractor and grain cart are also moving in the same normally forward direction. Now, additionally referring to FIGS. 2-7, there is illustrated an embodiment of a material transfer system 10 of the present invention including a material source vehicle 12 and a material receiving vehicle 18. Material receiving vehicle 18 includes a vehicle 20, a towed material container 22 and optionally additional towed material container 24 connected in series to towed material container 22. Additional towed material containers are also contemplated that can be connected in series, but are not illustrated. Towed material containers 22 and 24 are illustrated as grain carts, but other types of towed material containers are also contemplated. Material receiving vehicle 18, by way of this invention as further explained herein, backs towed material containers 22 and 24 in coordination with material source vehicle 12 so that material can be transferred to towed material containers 22 and 24 while material source vehicle 12 is moving in a forward direction 28 and towed material containers 22 and 24 are going in the same direction, which is a reverse direction to their normal direction of travel.

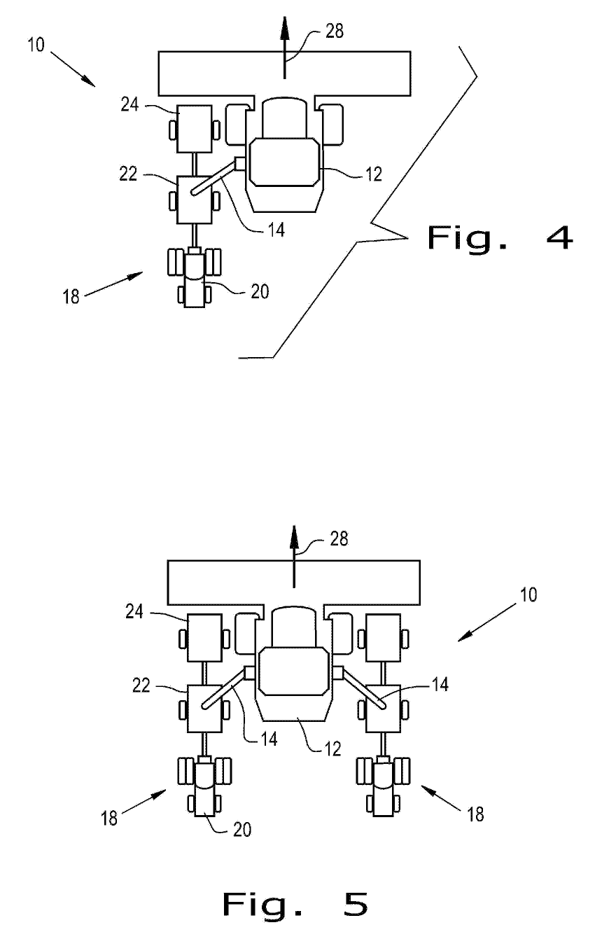

As illustrated in FIG. 4, towed material container 24 is traveling close to the header of material source vehicle 12 as towed material container 22 is being filed by discharge device 14. The present invention allowing for the efficient coordination of movement of the entire material transfer system 10.

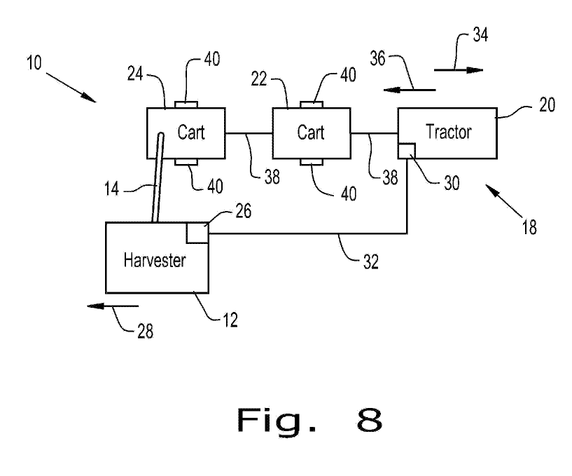

Now, additionally referring to FIG. 8, there is illustrated in a schematic form additional details of the present invention of a material transfer system 10. Material source vehicle 12 has a communicative controller 26 that is in communication with a communicative controller 30 coupled to vehicle 20. Information and/or control signals are sent by way of wireless link 32 so that communicative controller 30 receives information as to the current or future position of the end of discharge device 14, as well as any planned movements of material source vehicle 12 so as to preclude a collision between material source vehicle 12 and material receiving vehicle 18. Additionally, communicative controller 26 may control functions of material source vehicle 12, such as the preclusion of, or warning to an operator against, a sharp turn toward material receiving vehicle 18.

Vehicle 20 is connected to towed material container 22 by a tongue 38. Tongue 38 is pivotally connected to vehicle 20 and may be rigidly connected to towed material container 22. Tongue 38 also represents, for the purpose of discussion, a connection of a power transfer device and a communication link. The power transfer device may be in the form of hydraulic lines that allow the power plant of vehicle 20 to provide power to towed material container 22. It is also contemplated that power can be transferred by other connections such as electrical or pneumatic. The communication link allows communicative controller 30 to send control signals to towed material container 22 so that the backing of material receiving vehicle 18 can be accomplished in coordination with material source vehicle 12. Further, it is also contemplated that tongue 38 may be articulated and/or slid along a portion of towed material containers 22 and 24 as a way of effecting the steering control needed during the backing of material receiving vehicle 18.

Towed material containers 22 and 24 are each illustrated as having two wheels 40, which are ground engaging. Other ground engaging constructs are also contemplated such as more than two wheels and tracked constructs. Wheels 40 may be steerable and be under the control of the control signals sent thereto by communicative controller 30. Additionally, or instead of steerable wheels, wheels 40 can be separately powered to provide traction motive power to towed material containers 22 and 24. The separate powering of wheels 40 allow a skid-steer ability to towed material containers 22 and 24. The power supplied to wheels 40 as well as steering allows communicative controller 30 to send signals that coordinate the backing operation of material receiving vehicle 18. The reference herein to containers 22 and 24 as being “towed” is relative to the normal operation when material receiving vehicle 18 is proceeding in a direction 34, the consistent use of this term is for the purpose of uniformity and it is recognized that when material receiving vehicle 18 is moving in direction 36 that containers 22 and 24 are not being towed by vehicle 20. Vehicle 20 pushes tongue 38 or is pulled by tongue 38. A combination of physical pushing of tongue 38 and steering of wheels 40 and/or the powering of wheels 40 may be undertaken to provide the needed transfer of power along the steered pathway. Containers 22 and 24 may be self powered, such as with an on-board electrical generator. Containers 22 and 24 may also incorporate energy storage devices such as electrical battery, flywheel, pressurized gas chamber, or pressurized hydraulic fluid chamber. As material receiving vehicle 18 is moving in direction 36 communicative controller 30 controls the pathway taken in direction 36, which is substantially parallel with direction 28 as material receiving vehicle 18 approaches material source vehicle 12.

At least some of the power used to steer and/or move wheels 40 may come from an on-board power source or an on-board energy storage device. Power that is transferred to towed material containers 22 and 24 may be in the form of pressurized hydraulic fluid, pressurized gas or electricity.

In FIG. 7, a pathway is shown for material receiving vehicle 18, which may take place as material receiving vehicle 18 positions towed material containers 22 and 24. Material source vehicle 12 may have passed material receiving vehicle, which was further to the left, then material receiving vehicle may have pulled in behind material source vehicle 12 and then upon engaging the present invention material receiving vehicle 18 is actively steered to a path that is substantially parallel with direction 28. Then in a sequential manner towed material containers 22 and 24 receive the material from material source vehicle 12. Communications take place between communicative controllers 26 and 30 to coordinate the transfer of material. Once the material has transferred, or upon direction from an operator, material receiving vehicle 18, under the direction of communicative controller 30, disengages from the choreographed backing and comes to a gentle stop. If vehicle 20 is manned by an operator control may then be returned to the operator.

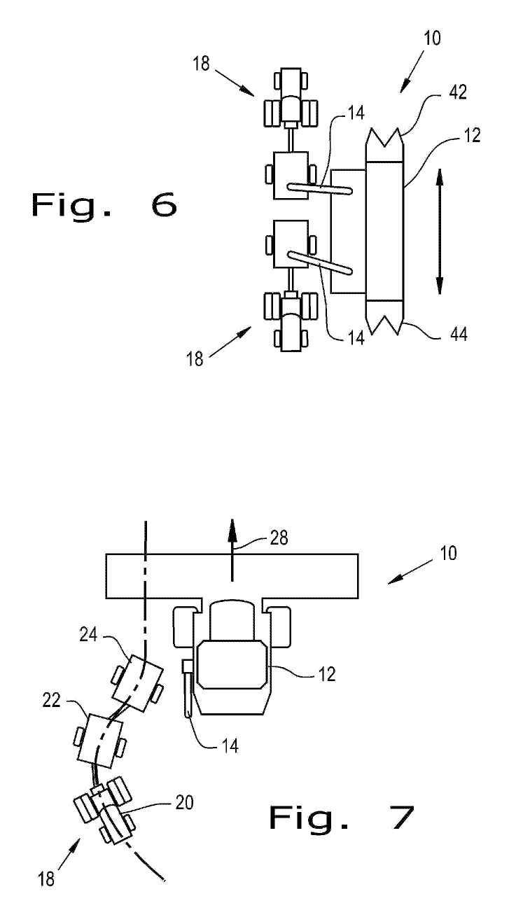

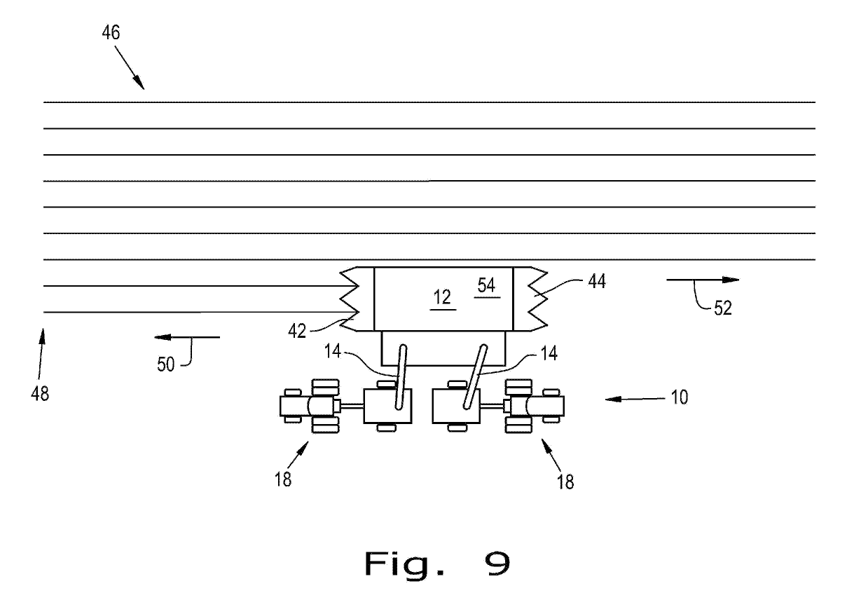

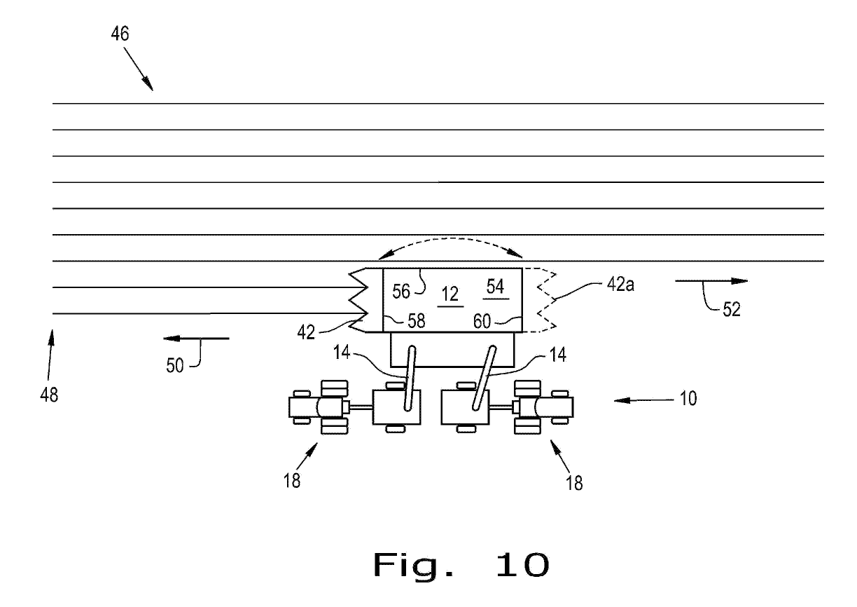

In FIGS. 6, 9 and 10, material source vehicle 12 is a bidirectional cane harvester with two material receiving vehicles 18 in attendance (but can do with just one). This illustrates the coordination of two vehicles, with one receiving cane billets and the other receiving cellulosic non-billet material. The bidirectional harvester may have two harvesting material gathering devices or harvesting heads 42 and 44 as shown in FIGS. 6 and 9, or as shown in FIG. 10, may have one material gathering device or harvesting head 42 that quickly transitions from one end of the transporting platform also known as base unit 54 of vehicle 12 to the other end. Base unit 54 is steerable and is bidirectional, thereby allowing harvesting to be performed in either direction 50 or 52, as shown in FIGS. 9 and 10. Base unit 54 supports material discharge devices 14 as well as material gathering devices 42 and 44. Transitioning mechanism 56, as shown in FIG. 10, is represented by the line along the side of base unit 54 and provides for the quick transitioning of material gathering device 42 to the position illustrated where material gathering device 42a is located.

Autonomous control of material receiving vehicle 18, coordinated with material source vehicle 12 improves the efficiency of material transfer. Preferably material receiving vehicle 18 has at least one material holding part which is detachable from a primary power source and the primary power source is in the rear relative to the direction of travel.

The problem of moving a grain/forage/cane cart in proximity to a combine/cane harvester is solved by the present invention by having the tractor back the cart in synchronization with the harvester rather than pull the cart. Because this is a virtually impossible task for even the most skilled operator, particularly with the speeds required and the poor visibilities of where the cart is near the combine, the autonomous guidance and safeguarding systems of the present invention are required.

Without limitation material source vehicle 12 could be a self-propelled forage harvester, a sugar cane harvester, a sugar beet harvester, a potato harvester, a hay baler, a cotton harvester, a rice harvester, a cut-to-length timber harvester, a mining machine, or a snow removal machine. Without limitation, material receiving vehicle 18 could be an agricultural tractor and one or more grain carts having one or more axels. In the description of the present invention, an agricultural tractor with one or more grain carts, each cart having one axle has been used. This simplification is for convenience in the description of the present invention, but one of ordinary skill in the art of vehicle trajectory control will be able to extend the invention to other hitch and axle configurations. In a preferred embodiment, wheels 40 of grain carts are powered as explained herein.

Two disadvantages of the prior art approach, as illustrated in FIG. 1, are first, the path of the tractor and grain cart extend beyond the width of the combine header. This causes problem for initial passes through a field to be harvested because material must be stored on the combine until the tractor/cart can pull along side the combine header. The second drawback is that only one grain cart can be pulled by the tractor because of space limitations in getting the cart within auger distance of the combine. This limits the material per tractor and tractor operator, decreasing efficiency and/or increasing costs. These two deficiencies are overcome by having the tractor push, rather than pull, the grain carts as shown in FIGS. 2-7. FIG. 2 shows towed material container 22 behind material source vehicle 12 during an initial pass through a field. FIG. 3 illustrates multiple grain carts with a single tractor/operator. FIG. 4 illustrates an advantage of the multiple grain carts with the single tractor/operator, wherein the auger can now easily reach the multiple carts. FIG. 5 illustrates multiple grain carts with multiple tractors/operators and the resulting coordination of the grain carts which are positioned anywhere relative to the combine such that the auger can reach. The discharge devices 14 may be discharging similar material, or dissimilar material from the different discharge devices 14. Similar material includes, without limitation, grain, silage, sugar cane billets, potatoes, sugar beets and the like. Dissimilar materials include, without limitations, the similar materials, but sorted by at least one attribute such as size, shape, color, protein content, sugar content, or oil content and the like. Dissimilar materials may also include the following pairs, without limitation: grain and stover, root crop and stones, cellulosic and non-cellulosic materials and the like.

FIG. 6 also illustrates high throughput combines which can provide dual outlets for a single material or the ability to continuously discharge material while one receiving vehicle pulls away and another vehicle is positioned. This also illustrates the situation when two material streams need to be handled, such as the above mentioned cane harvester, or for a corn harvester where one material stream is grain and the other material stream is cob or stalks.

Now additionally referring to FIGS. 9 and 10, there is illustrated a worksite with multiple rows 46 of un-harvested agricultural crops. Vehicle 12 can, without limitation, be a forage harvester, a grain combine, a snow blower, a dirt/compost/manure mover, a cotton harvester, a rice harvester, a sugar beet harvester or a potato harvester, even though the illustration and discussion herein, relative to FIGS. 6 and 9, is to a sugar cane harvester. Vehicle 12 includes a base unit 54 carrying a pair of (first and second) material gathering devices 42 and 44, which may be in the form of agricultural headers, at respective opposite (first and second) ends of base unit 54. Base unit 54 selectively provides motive power to vehicle 12, in a known manner.

Vehicle 12 can have two material discharge devices 14, which may both move billets from vehicle 12 to material receiving vehicles 18. However, arrangements with a single material discharge device 14 are also possible. Discharge devices 14 may, for example, be in the form of an auger, conveyor or chute for the discharging of material gathered by vehicle 12. The operator of vehicle 12 selects which one of material discharge devices 14 is activated so that a transition from moving the billets to one vehicle system 18 to the other vehicle system 18 can occur as one vehicle system 18 is filled. Once a vehicle system 18 is filled and the operator has switched the flow of billets to the other vehicle system 18, which, as illustrated in FIG. 8, may be an action that is under the control of communicative controllers 26 and 30, the filled vehicle system 18 disengages from the control of the present invention and the operator takes the filled vehicle system 18 to a place where it is unloaded. The present invention advantageously allows vehicle 12 to continue harvesting without stopping while material receiving systems are being switched. Although FIGS. 9 and 10 illustrate two vehicle systems 18 harvesting can also take place with just one vehicle system 18, with two vehicle systems 18 being involved in the switching of the material discharge from one vehicle system 18 to another vehicle system 18.

As illustrated in FIG. 9, vehicle 12, here shown as a bidirectional material source vehicle 12, is proceeding in direction 50 to the end of rows 48 using material gathering device 42. Once vehicle 12 arrives at the end of rows 48, vehicle 12 is positioned to start on the adjacent set of rows using material gathering device 44 to thereby harvest in direction 52, with material receiving vehicles 18 each reversing their direction to correspond with direction 52, without reorienting material receiving vehicles 18. The present invention advantageously eliminates the time consuming 180 degree turns and associated reorienting of material source vehicle 12 and the material receiving vehicles 18. The bidirectional harvester advantageously engages a new set of rows 46 upon reaching the end of rows 48, by having dual material gathering devices 42 and 44 as illustrated in FIG. 9.

Alternatively, as illustrated in FIG. 10, vehicle 12 may include a single movable material gathering device 42 which quickly transfers its position to the opposite end of base unit 54 (schematically shown by the curved dashed arrow leading to the position of material gathering device 42a, also shown in dashed lines). More particularly, a transitioning mechanism 56 such as a swiveling arrangement, a translating arrangement, or other arrangement transfers material gathering device 42 to the position of material gathering device 42a, so as to engage the next set of rows 46 in direction 52. Transitioning mechanism 56 is represented as a line that extends along the side of vehicle 12 from where material gathering device 42 is located to where material gathering device 42a is positioned. Interface devices 58 and 60 represented by lines are carried by base unit 54 and are coupled to material gathering device 42, 42a either in the position shown where material gathering device 42 is located or where material gathering device 42a is located. Interface devices 58 and 60 couple to material gathering devices 42 and/or 42a and pass the gathered material from the material gathering devices 42, 42a through to the material source vehicle 12.

While vehicle 12 travels in first travel direction 50 material receiving vehicle 18 has a first orientation as it also travels in first travel direction 50. While vehicle 12 travels in second travel direction 52 material receiving vehicle 18 has a second orientation as it travels in second travel direction 52 with the first orientation being substantially opposite to the second orientation, thereby continuing the coordinated travel path of material receiving vehicle 18 relative to vehicle 12 as the material in rows 46 is harvested in direction 52 by the bidirectional travel of vehicle 12.

The present invention is carried out as a method of gathering material with vehicle 12 by gathering the material in direction 50 with material gathering device 42 and subsequently gathering material in direction 52 with either material gathering device 44, or with material gathering device 42a that has been transitioned to interface device 60, without substantially altering an orientation of base unit 54 of vehicle 12. The present invention also coordinates the travel during material transfer and during direction reversal, without reorientation, of material receiving vehicles 18.

The position, orientation and other state variables associated with vehicles 12 and 18 may be obtained by a variety of sensor combinations and placements that send information to communicative controllers 26 and 30. Sensed data may be combined with known geometry of vehicle elements to calculate positions of edges, wheels, drawbars, etc. as part of the implementation of the present invention.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A bidirectional material source vehicle, comprising:
a base unit movable in a first travel direction and a generally opposite second travel direction; and
at least one material gathering device carried by said base unit, said at least one material gathering device coupled to a first end of said base unit when said base unit is traveling in the first travel direction and at least one said material gathering device gathering material in the first travel direction, said at least one material gathering device coupled to a second end of said base unit when said base unit is traveling in the second travel direction and at least one said material gathering device gathering material in the second travel direction.

2. The bidirectional material source vehicle of claim 1, wherein said at least one material gathering device includes a first material gathering device connected with said first end of said base unit, and a second material gathering device connected with said second end of said base unit.

3. The bidirectional material source vehicle of claim 2, further comprising at least one material discharge device coupled to said base unit, both said first material gathering device and said second material gathering device being configured to provide material that is gathered thereby to said at least one material discharge device, the bidirectional material source vehicle being configured to coordinate a travel path of a material receiving vehicle to thereby receive said material from said at least one material discharge device.

4. The bidirectional material source vehicle of claim 3, wherein while the bidirectional material source vehicle travels in the first travel direction said material receiving vehicle has a first orientation and travels in the first travel direction, and while the bidirectional material source vehicle travels in the second travel direction said material receiving vehicle has a second orientation and travels in the second travel direction, said first orientation and said second orientation being substantially opposite thereby continuing the coordinated travel path of said material receiving vehicle relative to the bidirectional material source vehicle.

5. The bidirectional material source vehicle of claim 1, wherein said at least one material gathering device is selectively connected with either of said first end and said second end of said base unit.

6. The bidirectional material source vehicle of claim 5, further comprising at least one material discharge device coupled to said base unit, said material gathering device being configured to provide material that is gathered thereby to said at least one material discharge device, the bidirectional material source vehicle being configured to coordinate a travel path of a material receiving vehicle to receive said material from said at least one material discharge device.

7. The bidirectional material source vehicle of claim 6, wherein while the bidirectional material source vehicle travels in the first travel direction said material receiving vehicle has a first orientation, and while the bidirectional material source vehicle travels in the second travel direction said material receiving vehicle has a second orientation, said first orientation and said second orientation being substantially opposite thereby continuing the coordinated travel path of said material receiving vehicle relative to the bidirectional material source vehicle.

8. A bidirectional material source vehicle, comprising:
a base unit movable in a first travel direction and a generally opposite second travel direction, said base unit including a first interface device associated with a first end of said base unit and a second interface device associated with a second end of said base unit; and
at least one material gathering device connectable to said first interface device when said base unit is traveling in the first travel direction and connectable to said second interface device when said base unit is traveling in the second travel direction, at least one said material gathering device gathering material when traveling in said first travel direction and when traveling in said second travel direction.

9. The bidirectional material source vehicle of claim 8, wherein said at least one material gathering device includes a first material gathering device connected to said first interface device, and a second material gathering device connected to said second interface device.

10. The bidirectional material source vehicle of claim 9, further comprising at least one material discharge device coupled to said base unit, both said first material gathering device and said second material gathering device being configured to provide material that is gathered thereby to said at least one material discharge device, the bidirectional material source vehicle being configured to coordinate a travel path of a material receiving vehicle to thereby receive said material from said at least one material discharge device.

11. The bidirectional material source vehicle of claim 10, wherein while the bidirectional material source vehicle travels in the first travel direction said material receiving vehicle has a first orientation, and while the bidirectional material source vehicle travels in the second travel direction said material receiving vehicle has a second orientation, said first orientation and said second orientation being substantially opposite thereby continuing the coordinated travel path of said material receiving vehicle relative to the bidirectional material source vehicle.

12. The bidirectional material source vehicle of claim 8, wherein said at least one material gathering device includes a single material gathering device which is selectively connected to either of said first interface device and said second interface device.

13. The bidirectional material source vehicle of claim 12, further comprising at least one material discharge device coupled to said base unit, said material gathering device being configured to provide material that is gathered thereby to said at least one material discharge device, the bidirectional material source vehicle being configured to coordinate a travel path of a material receiving vehicle to receive said material from said at least one material discharge device.

14. The bidirectional material source vehicle of claim 13, wherein while the bidirectional material source vehicle travels in the first travel direction said material receiving vehicle has a first orientation and travels in the first travel direction, and while the bidirectional material source vehicle travels in the second travel direction said material receiving vehicle has a second orientation and travels in the second travel direction, said first orientation and said second orientation being substantially opposite thereby continuing the coordinated travel path of said material receiving vehicle relative to the bidirectional material source vehicle.

15. A method of gathering material with a bidirectional material source vehicle, comprising the steps of:
moving a base unit of the bidirectional material source vehicle in a first travel direction, said base unit carrying at least one material gathering device coupled to a first end of said base unit when said base unit is traveling in the first travel direction and said at least one material gathering device gathering material in the first travel direction; and
moving said base unit of the bidirectional material source vehicle in a second travel direction, the second travel direction being generally opposite of the first travel direction, said at least one material gathering device being coupled to a second end of said base unit when said base unit is moving in the second travel direction and said at least one material gathering device gathering material in the second travel direction.

16. The method of claim 15, further comprising the step of discharging the material through at least one material discharge device while the bidirectional material source vehicle is moving in either the first travel direction or the second travel direction.

17. The method of claim 16, wherein said at least one material gathering device comprises a single material gathering device which is selectively connected with either of said first end of said base unit and said second end of said base unit.

18. The method of claim 17, further comprising the step of coordinating a travel path of a material receiving vehicle to receive the material from said at least one material discharge device in either of the first travel direction and the second travel direction, said material receiving vehicle having a first orientation while traveling in the first travel direction and a second orientation while traveling in the second travel direction, said first orientation and said second orientation being substantially opposite.

19. The method of claim 16, wherein said at least one material gathering device includes a first material gathering device connected with said first end of said base unit, and a second material gathering device connected with said second end of said base unit.

20. The bidirectional material source vehicle of claim 1, wherein the bidirectional material source vehicle is one of a harvester, a forage harvester, a sugar cane harvester, a sugar beet harvester, a potato harvester, a hay baler, a cotton harvester, a rice harvester, a cut-to-length timber harvester, a mining machine, and a snow removal machine.
